(19) United States
(12) Patent Application Publication
(10) Pub. No.: US 2011/0171373 A1
(43) Pub. Date: Jul. 14, 2011

(54) METHOD AND APPARATUS FOR MANUFACTURING HEAT-EXCHANGING COIL FIN UNIT AND HOUSING UNIT OF AIR HANDLING SYSTEM WITH ANTIMICROBIAL FUNCTION

(75) Inventors: Myung Ho Lee, Inchon (KR); Gu Wan Jeong, Inchon (KR)

(73) Assignees: NANOPOLY CO., LTD., Seoul (KR); KOREA AIR CONDITIONING ENGINEERING COMPANY, Kyonggi-do (KR)

(21) Appl. No.: 11/915,343

(22) PCT Filed: Apr. 7, 2006
(86) PCT No.: PCT/KR2006/001279

§ 371 Date: Aug. 13, 2008

(30) Foreign Application Priority Data
May 24, 2005 (KR) 10-2005-0043714
May 31, 2005 (KR) 10-2005-0045854
Jun. 3, 2005 (KR) 10-2005-0047519
Jun. 24, 2005 (KR) 10-2005-0055238

(51) Int. Cl. B05D 5/00; B05D 3/12; B05D 5/06; B05D 3/00; B05D 1/18; B05C 11/00; B05C 11/02; B05C 9/14; B82Y 30/00

(52) U.S. Cl. 427/160; 427/401; 427/289; 118/37; 427/292; 977/773

(57) ABSTRACT

The present invention relates to a method and an apparatus for manufacturing a heat exchanging fin unit and a housing unit in an air handling system with antimicrobial function, the aluminum coil fin unit and the housing unit being coated with metal nano particles including nano silver particles to have antibiosis, sterilization and antimicrobial functions.

According to a preferred embodiment, the metal nano particles are mixed with a hydrophilic paint and a preventing paint to be coated on the surface of the heat exchanging aluminum coil fin unit. The nano particle is one or its mixture selected from the group consisting of Pt, Au, Ag, Cu and TiO₂ and has a density of 1,000 ppm to 10,000 ppm and a size of 20 nm or less. Preferably, the nano particle has a size of 1 to 2 nm and a density of 100 ppm to 200 ppm to provide a high sterilization effect.

### TECHNICAL FIELD

The present invention relates to method for manufacturing heat-exchanging coil fin unit and housing unit of air handling system(air conditioning system) with anti-microbial function such as air conditioner and apparatus for the same, more particularly, a method for manufacturing a heat-exchanging coil unit and a housing unit of an air conditioning system with anti-microbial function, which comprises coating treatment of surface of the coil fin unit and the housing unit with anti-microbial metal nano particles to offer anti-microbial, hygienic and anti-fungal properties so that it can originally remove fungi, bacteria harmful for human beings and supply clean and hygienic air from the air conditioning system into a room.

### BACKGROUND ART

It is commonly known that an air conditioning system as illustrated in FIG. 1 has a typical structure, in which a filter 12 is equipped at one side in a casing 10 to remove dust or impurities contained in air OA fed from outside and/or recycled air RA, arranged with a heat exchanger 14 consisting of a circular copper pipe 14a through which a coolant flows and an aluminum coil fin member 14b at rear side of the filter 12. At rear of the heat exchanger, there are provided an air blower 16 which passes through the filter 12 and blows heat-exchanged air SA by the heat-exchanger into the room, an impeller 18 which blows the heat-exchanged air through the air blower 16, and a vacuum motor 18 for driving the impeller.

That is, the air conditioning system illustrated in FIG. 1 enables mutual heat-exchange between the coolant and air OA/RA fed into the room through the circular copper pipe 14a that contacts with surface of the aluminum coil fin member 14b of the heat exchanger 14, and control of interior temperature by feeding the heat exchanged air SA into the room.

Generally, as to a process for manufacturing the aluminum coil fin member 14b of the heat exchanger 14, lubricant oil or liquid silicone which is a low viscosity evaporable surface treatment agent and has function of a releasing agent or a mold protective agent is applied to surface of the aluminum coil fin member 14b in a sheet form so that the aluminum coil fin member does not adhere to the mold when the aluminum coil fin member 14b is under a continuous punching process in multiple steps.

Additionally, the aluminum coil fin member 14b is dipped in a leak removing solution for examining whether a heat exchanger copper pipe leaks water during the punching process.

In the heat-exchanging process, it generally forms dewdrops on surface of the aluminum coil fin member 14b contacting with the circular copper pipe 14a in which the coolant flows, since temperature of the air passing through between fin member and surface of the fin member is higher than that of surface of the fin member. Therefore, the heat exchanger coil fin member 14b always keeps a higher humidity at surface thereof, has a fear of proliferation of microorganisms such as fungi and bacteria, is unsanitary and causes a wide variety of bacterial diseases.

Accordingly, it strongly needs an improved aluminum coil fin member 14b to fabricate a heat exchanger 14 and a housing unit of the heat exchanger 14, both of which are harmless to human body and have strong and continuous anti-microbial performance.

In consideration of the above circumstance, an example of conventional methods for manufacturing an aluminum fin member for heat-exchanging includes in principle preparing a crude panel for the aluminum fin member in a constant wide width, for instance, of not less than 1 m, applying a coating mixture of anti-microbial agent and hydrophilic paint or anti-rusting paint to both sides of the crude panel, cutting the coated panel into extended pieces having a width of about 300 mm and winding each of the pieces around a roll in a length of above 1,000 m.

However, the above process has a disadvantage in that manufacturers of air conditioning system should reserve for sufficient amount of aluminum fin units and accumulate stock of goods, although it can achieve mass production of heat-exchanging aluminum fin units.

As for anti-microbial agents used in coating aluminum fin unit, it has been disclosed general organic and chemical preservatives, for example, in JP Laid-Open No. 2-101395 that short acting and long acting anti-microbial agents are applied to a hydrophilic coating film of benzimidazole compound after forming the hydrophilic coating film. Also, there are organo arsenic compounds such as 10,10-oxybisphenoxy arsine OBPA described in U.S. Pat. No. 4,683,080, or tributyl tin, copper dioxide, copper in powder state and the like to be admixed with conventional hydrophilic paints and rust-resisting paints and used in coating aluminum fin unit. However, in view of techniques for processing such anti-microbial agents, all of the above proposed methods are nothing but the anti-microbial treatment typically carried out by manufacturers of aluminum coil fin units and have not advantage to those for manufacturing air conditioning systems.

As to use of powdery copper, it is generally used copper powder having a particle size in micrometer units after pulverizing copper into powders. Such particle size is too large and possibly causes damage of a processing mold when the aluminum coil fin unit is formed by molding processes, in addition to, leads to a difficulty in maintaining satisfactory anti-microbial effect since it has not a high level of energy on surface of the copper powder.

In order to overcome the above problem, it recently tends to utilize silver particles Ag or ions Ag⁺ as the anti-microbial agent or sterilizer. But, methods for selecting and using Ag particles or Ag⁺ ions and/or applications thereof to raw materials of the aluminum fin unit have disadvantages in that such methods are not economical, have obstacles in processing, and lack strong anti-microbial and sterilizing effects in short term or continuous durability of the anti-microbial and sterilizing effects.

For instance, Korean Laid-Open No. 10-2004-0095581 discloses use of Ag nano particles which have a particle size of not more than 300 nm and upper limit of the particle size of about 10 fold more than that of metal nano particles according to the present invention described below. It is understood from the above document that amount of Ag nano particles is up to 35 wt. % and excessively used, compared with total weight of electrodeposition paint applied to the aluminum fin unit. In addition, when Ag particles are formed from silver compounds such as AgNO₃, nitrate groups containing ions NO₃— as counter ions of Ag ions Ag⁺, are not removed from the Ag particles and cause oxidation of film surface of the aluminum coil fin unit. As a result, the known method does not keep excellent durability for long term.

Korean Laid-Open No. 10-2004-0068489 proposes a method for preparing anti-microbial hydrophilic paint useful for manufacturing aluminum coil fin unit that uses Ag particles formed by ion-reduction of silver nitrate AgNO₃ in a surfactant receptor. Such method preferably uses Ag particles having a particle size of 20 nm. However, Ag particles obtained by the above method have a maximum particle size of 500 nm and a concentration of 3,000 ppm if the maximum amount of Ag particles used is expected up to 10 wt. % relative to total weight of a paint composition with even the lowest concentration of 30,000 ppm, thereby resulting in excessive amount of Ag particles to be used.

Additionally, the above method further includes addition of isothiazoline based anti-fungal agents to enhance the anti-microbial ability. But, since Ag particles are used without removing NO₃— ions, there is a strong possibility to occur corrosion of coating film on the aluminum coil fin unit. When the anti-fungal agent combined with UV paint is used, it increases a possibility of yellowing reaction to change color of the coating film into brown.

Furthermore, Korean Laid-Open No. 10-2002-008762 suggests a method that conducts plasma treatment of surface of a metal material to vapor deposit a polymer film on the surface, and forms an anti-microbial layer between the metal surface and the vapor-deposited polymer film. This method has a drawback of requiring highly expensive instruments for plasma treatment.

Meanwhile, Korean Laid-Open Nos. 10-2005-0018918 and 10-2005-0012202 propose a method for manufacturing air-conditioner coil that comprises coating of colloidal sol solution dispersed with silver nano particles on a cold coil and/or vapor-deposition of nano silver particles. As to the method using anodic oxidation process, it employs Ag colloidal solution without removing NO₃— ions, thereby raising the possibility of surface corrosion. On the other hand, the method using plasma vapor deposition has defects of requiring expensive instruments and lowering productivity.

Briefly, the anti-microbial agents proposed by the above methods are insufficient to demonstrate strong sterilizing effect of 99% or more within 1 hour, and do not reach a level to keep anti-microbial effect until a lapse of 24 hours. Consequently, it needs to increase amount of the anti-microbial agent in order to ensure a desirable level of anti-microbial ability.

In addition, it cannot accomplish a uniform distribution of metal nano particles impregnated with hydrophilic paint or rust-resisting paint, thereby taking a long time to exhibit anti-microbial effect.

In order to avoid such poor formability, it needs to increase amount of the paraffin oil and the rubber. But, if the amount of the paraffin oil and the rubber is increased, the cover may have insufficient scratch-resistance.

### DISCLOSURE OF THE INVENTION

### Technical Problem

Accordingly, the present invention is based on the above described known arts in order to overcome the foregoing problems.

Therefore, a first object of the present invention is to provide a method for manufacturing a heat-exchanging coil fin unit of an air handling system(that is, an air conditioning system) with anti-microbial function which endows strong anti-fungal, anti-microbial and sterilizing effects to the coil fin unit for a long term and originally removes a variety of bacteria and fungi possibly inhabiting on surface of the coil fin unit by blending typically hydrophilic paint or rust-resisting paint as a surface coating agent with metal nano particles having a particle size of 1 to 20 nm selected from a group consisting of platinum Pt, gold Au, silver Ag, copper Cu and titanium dioxide TiO₂ alone or in combination with a constant mixing ratio, and applying the mixture to surface of the heat-exchanging aluminum coil fin unit, and which enables air supply into a room through hygienically treated surface of the coil fin unit.

A second object of the present invention is to provide a method for manufacturing a heat-exchanging coil fin unit of an air handling system with anti-microbial function which endows strong anti-fungal, anti-microbial and sterilizing effects to the coil fin unit for a long term and originally removes a variety of bacteria and fungi possibly inhabiting on surface of the coil fin unit by blending typical low viscosity evaporable lubricant oil or liquid silicone to function as a releasing agent or a mold protective agent with silver Ag particles having a particle size of not more than 20 nm in a constant mixing ratio, and continuously applying the mixture to surface of an aluminum sheet for fabricating the heat-exchanging aluminum coil fin unit (that is, surface of the aluminum coil fin unit), especially which continuously maintains excellent anti-fungal effect by using a small amount of silver nano particles compared with conventional materials, and which enables air supply into a room through hygienically treated surface of the aluminum coil fin unit in the air conditioning system by strongly sterilizing bacteria within 1 hour.

A third object of the present invention is to provide a method for manufacturing a heat-exchanging coil fin unit of an air handling system with anti-microbial function which endows strong anti-fungal, anti-microbial and sterilizing effects to the coil fin unit for a long term and originally removes a variety of bacteria and fungi possibly inhabiting on surface of the coil fin unit by blending typical urethane and acryl based UV paints with metal nano particles having a particle size of not more than 20 nm selected from a group consisting of Pt, Au, Ag, Cu and TiO₂ alone or in combination with a constant mixing ratio, continuously applying the mixture to surface of the coil fin unit, drying and curing the coated coil fin unit before a punching process, and which enables air supply into a room through hygienically treated surface of the aluminum coil fin unit, in addition to, an apparatus for manufacturing the heat-exchanging coil fin unit.

Still, a fourth object of the present invention is to provide a method for manufacturing a heat-exchanging coil fin unit and a housing unit of an air handling system with anti-microbial function, which continuously exhibits excellent anti-fungal and sterilizing effects using anti-microbial metal nano particles by adding a small amount of metals selected from a group consisting of Pt, Au, Ag, Cu and TiO₂ to acryl or alkyd based binder, further adding microfine particles of clay to the binder, and applying the binder mixture to surface of the heat-exchanging coil fin unit and the housing unit.

### Technical Means to Solve the Problem

In order to accomplish the first object of the present invention, a first embodiment which is practically embodied in consideration that the first object cannot be accomplished if the coil fin unit exhibits insufficient anti-fungal, anti-microbial and sterilizing effects even though anti-microbial metal nano particles are used, comprises: a process of demonstrating strong anti-microbial and anti-fungal effects of the aluminum coil fin unit without requiring commonly available chemical preservatives or toxic materials by using metal nano particles with a particle size of not more than 20 nm and, preferably, 1 to 2 nm selected from a group consisting of Pt, Au, Ag, Cu and TiO₂; a process of uniformly dispersing metal nano particles over the aluminum coil fin unit by using a mixture of the metal nano particles with typically hydrophilic paint and rust-resisting paint, using a water soluble solvent to homogeneously disperse the metal nano particles in the paint without settling agglomerate thereof and maintain environmental affinity and compatibility of the metal nano particles with the paint and stabilizing the dispersion; and a process of removing nitrate groups NO₃— as counter ions of silver ions Ag⁺ generated during production of colloidal solution when Ag particles are used, especially, Ag nano particles of metals prepared by using silver nitrate AgNO₃ are used. As a result of the first embodiment, the aluminum coil fin unit has continuously excellent anti-microbial effect and durability without occurring corrosion of surface of the aluminum coil fin unit.

In order to accomplish the second object of the present invention, a second embodiment comprises: a process of demonstrating strong anti-fungal, anti-microbial and sterilizing effects of the aluminum coil fin unit by blending evaporable lubricant oil or liquid silicone to function as a releasing agent or a mold protective agent with Ag particles having a particle size of not more than 20 nm and, preferably, 1 to 2 nm for enhancing sterilization ability, and continuously applying the mixture to surface of an aluminum sheet type of crude panel for fabricating the heat-exchanging aluminum coil fin unit before a punching process; and a process of removing nitrate groups NO₃— as counter ions of silver ions Ag⁺ generated during production of colloidal solution when Ag particles are used, especially, Ag nano particles of metals prepared by using silver nitrate AgNO₃ are used. As a result of the second embodiment, the aluminum coil fin unit has continuously excellent anti-microbial effect and durability without occurring corrosion of surface of the aluminum coil fin unit and discoloration into yellow color.

In order to accomplish the third object of the present invention, a third embodiment comprises: a process of demonstrating strong anti-fungal, anti-microbial and sterilizing effects of the aluminum coil fin unit by blending typical urethane and acryl based UV paints with metal nano particles with a particle size of not more than 20 nm and, preferably, 1 to 2 nm for enhancing the sterilizing effect, selected from a group consisting of Pt, Au, Ag, Cu and TiO₂, provided that the UV paint is a rapid drying UV paint sufficient to promptly form and dry a coating film and not to adversely effect to a process flow rate of about 1.5 m/minute during punching, cutting and processing steps of the aluminum coil fin unit and thickness of the coating film is the minimum value to reduce the drying velocity without causing interference against heat transfer efficiency.

Additionally, when Ag particles are used, especially, Ag nano particles of metals prepared by using silver nitrate AgNO₃ are used, the aluminum coil fin unit has continuously excellent anti-microbial effect and durability without occurring corrosion of surface of the aluminum coil fin unit and discoloration into yellow color by removing nitrate groups NO₃— ions as counter ions of silver ions Ag⁺ generated during production of colloidal solution.

Conventional methods necessarily need alternative anti-microbial treatment processes. On the contrary, a fourth embodiment to accomplish the fourth object of the present invention, comprises a process of coating surfaces of a heat-exchanging coil fin unit and a housing unit thereof by simply dipping metal nano particles as an anti-microbial material in a bath containing a leak removing solution in order to examine leak of a heat-exchanging copper pipe, and adding clay nano particles and a binder to the leak removing solution in a constant mixing ratio without alternative processes in order to eliminate lowering of surface adhesiveness and surface durability of the nano particles coated on surfaces of the coil fin unit and the housing unit, so that the anti-microbial surface treatment is successfully and naturally accomplished on the aluminum coil fin unit and the housing unit during the leak examination process.

When Ag nano particles are used in terms of AgNO₃ compound among the above described metals, it can continuously endow anti-microbial ability while not causing corrosion of surface of the aluminum coil fin unit and yellowing thereof by removing nitrate groups NO₃— ions as counter ions of silver ions Ag⁺ generated during production of colloidal solution.

### Advantageous Effects

According to the first embodiment of the present invention, it can achieve a uniform distribution of metal nano particles on surface of an aluminum coil fin unit by blending typically hydrophilic paint or rust-resisting paint as a surface coating agent with metal nano particles having a particle size of 1 to 20 nm selected from a group consisting of Pt, Au, Ag, Cu and TiO₂ alone or in combination with a constant mixing ratio, and applying the mixture to surface of the aluminum coil fin unit, so that it can originally remove a variety of bacteria and fungi possibly inhabiting on surface of the aluminum coil fin unit and reliably sterilize bacteria within 1 hour.

Also, when Ag nano particles among the above described metals formed by using AgNO₃ compound are used, the aluminum coil fin unit can continuously have excellent durability without corrosion of surface of the aluminum coil fin unit by using Ag nano particles free from nitrate groups NO₃— ions as counter ions of silver ions Ag⁺ generated during production of colloidal solution.

Additionally, the inventive method enables economical production of goods by using generally known paints containing hydrophilic and dust-proofing ingredients to be admixed with a small amount of metal nano particles without difficulties in processing. Furthermore, the present invention can provide an air conditioning system having the heat-exchanging coil fin unit of the present invention which is hygienic and eco-friendly produced by the present invention and by preparing a mixture in the water soluble and colloidal condition with non-toxic metal nano particles and, in addition to, show other advantages.

According to the second embodiment of the present invention, the present invention can flexibly produce a desired quantity of anti-microbial fin units without alternative process for coating anti-microbial film by blending lubricant oil or liquid silicone to function as a releasing agent or a mold protective agent with microfine Ag particles having a particle size of not more than 20 nm, and continuously applying the mixture to surface of an aluminum sheet type of crude panel for fabricating the heat-exchanging aluminum coil fin unit before a punching process, so that it can reduce stocks load caused by already produced anti-microbial fin unit sheets, especially, control extent of anti-microbial, sterilizing and anti-fungal performances and simultaneously offer economical benefit and anti-microbial effect, thereby having advantage in manufacturing smaller amount of single goods.

The aluminum fin unit treated by the second embodiment of the present invention has a uniform distribution of metal nano particles on surface thereof, and is effective to originally remove a variety of bacteria and fungi possibly inhabiting on the surface and strongly sterilize bacteria within 1 hour. Also, when Ag nano particles among the above described metals formed by using AgNO₃ compound are used, the aluminum coil fin unit can continuously have excellent durability without corrosion of surface of the aluminum coil fin unit by using Ag nano particles free from nitrate groups NO₃— ions as counter ions of silver ions Ag⁺ generated during production of colloidal solution.

Preferably, the second embodiment of the present invention enables economical and efficient production of the product by adding a process, which comprises blending the releasing agent, lubricant oil or liquid silicone with a small amount of metal nano particles and applying the mixture on surface of the aluminum coil fin unit, to conventional aluminum punching process without particular modification of processes.

Further, according to the third embodiment of the present invention, the present invention can flexibly produce a desired quantity of anti-microbial fin units without alternative process for coating anti-microbial film by blending UV paint with metal nano particles having a particle size of not more than 20 nm selected from a group consisting of microfine Pt, Au, Ag, Cu and TiO₂ alone or in combination with a constant mixing ratio, and applying the mixture to surface of the aluminum coil fin unit, so that it can reduce stocks load caused by already produced anti-microbial fin unit sheets, especially, control extent of anti-microbial, sterilizing and anti-fungal performances and simultaneously offer economical benefit and anti-microbial effect, thereby having advantage in manufacturing smaller amount of single goods.

The aluminum fin unit treated by the third embodiment of the present invention has a uniform distribution of metal nano particles on surface thereof and is effective to originally remove a variety of bacteria and fungi possibly inhabiting on the surface and strongly sterilize bacteria within 1 hour. Also, when Ag nano particles among the above described metals formed by using AgNO₃ compound are used, the aluminum coil fin unit can continuously have excellent durability while not causing occurrence of corrosion of surface of the aluminum coil fin unit and yellowing of UV paint by using Ag nano particles free from nitrate groups NO₃— ions as counter ions of silver ions Ag⁺ generated during production of colloidal solution.

The third embodiment of the present invention enables economical and efficient production of the product by adding a process, which comprises blending UV paint with a small amount of metal nano particles and applying the mixture on surface of the aluminum coil fin unit, to conventional aluminum punching process without particular modification of processes.

Still further, according to the fourth embodiment of the present invention, the present invention can conduct surface treatment in a short term, increase adhesiveness of metal nano particles and surface durability by surface treating the heat-exchanging fin unit and the housing unit with metal nano particles having a particle size of not more than 20 nm selected from a group consisting of microfine Pt, Au, Ag, Cu and TiO₂ alone or in combination with a constant mixing ratio, and using acryl or alkyd based binder containing clay nano particles to accelerate the surface treatment.

Conventionally, the anti-microbial surface treatment is restricted to only the aluminum fin unit. On the contrary, the fourth embodiment of the present invention conducts the anti-microbial surface treatment over entire portion of the housing unit including the aluminum fin unit. Such anti-microbial surface treatment is carried out during dipping step of a leak examination process subjected to finished products, thereby simultaneously achieving convenience of the anti-microbial treatment, economical benefit and preferable anti-microbial effect.

The aluminum fin unit treated by the fourth embodiment of the present invention is also effective to originally remove a variety of bacteria and fungi possibly inhabiting on the surface, strongly sterilize bacteria within 1 hour, and always maintain whole of the air conditioning system in sterilized condition so that air flowed in the room is continuously kept in hygienic condition. Also, when Ag nano particles among the above described metals formed by using AgNO₃ compound are used, the aluminum coil fin unit can continuously have excellent durability while not causing occurrence of corrosion of surface of the aluminum coil fin unit and discoloration such as yellowing by using Ag nano particles free from nitrate groups NO₃— ions as counter ions of silver ions Ag⁺ generated during production of colloidal solution.

### BRIEF DESCRIPTION OF THE DRAWINGS

The above object, features and advantages of the present invention will become more apparent to those skilled in the related art from the following preferred embodiments of the invention in conjunction with the accompanying drawing.

FIG. 1 is a schematic view illustrating internal construction of an air handling system(that is, an air conditioning system) equipped with a heat-exchanging coil fin unit and a housing unit according to the present invention;

FIG. 2 is TEM (Transmission Electron Microscope) photograph illustrating distribution of Ag particles with an average particle size of about 7 nm, which are used in surface treatment of the heat-exchanging coil fin unit and the housing unit according to the present invention;

FIG. 3 is TEM photograph illustrating distribution of Ag particles with an average particle size ranged from 1 to 2 nm, which are used in surface treatment of the heat-exchanging coil fin unit and the housing unit according to the present invention;

FIG. 4 shows a coating treatment process for surface of a sheet form of aluminum panel used in manufacturing the aluminum coil fin unit by using a mixture of lubricant oil or liquid silicone to function as a releasing agent or a mold protective agent and Ag particles according to the second embodiment of the present invention;

FIG. 5 is an explanation of the method for manufacturing the heat-exchanging aluminum coil fin unit by using a coating apparatus according to the third embodiment of the present invention;

FIG. 6 is an enlarged cross-sectional view of a roller mounted on front end of a coating thickness control bar as shown in FIG. 5;

FIG. 7 shows a dipping condition of the heat-exchanging coil fin unit and the housing unit according to the fourth embodiment of the present invention;

FIG. 8 is AFM (Atomic Force Microscope) photograph of clay coated on surfaces of the heat-exchanging coil fin unit and the housing unit according to the fourth embodiment of the present invention; and

FIG. 9 is TEM photograph of clay nano particles with a particle size of 200 nm according to the fourth embodiment of the present invention.

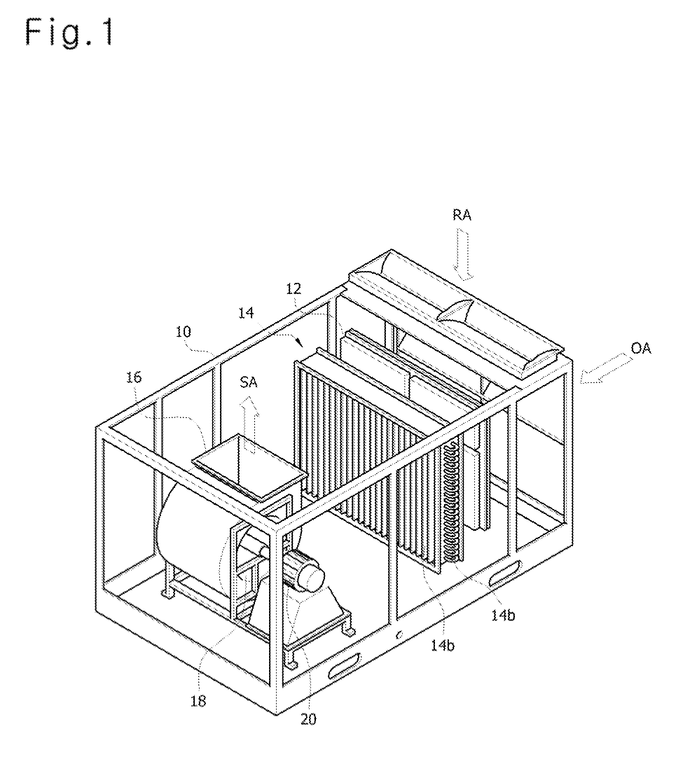

Features of the present invention described above and other advantages will be more clearly understood by the following non-limited examples and comparative examples, which are not intended to restrict the scope of the invention but are instead illustrative embodiments of the present invention. Accordingly, it will be obvious to those skilled in the art that the present invention is not restricted to the specific matters stated above and the examples below.

### BEST MODE FOR CARRYING OUT THE INVENTION

As to the first embodiment of the present invention, metal nano particles such as Pt, Au, Ag, Cu, TiO₂, etc. which are added to typically hydrophilic paint and rust-resisting paint and employed for coating a heat-exchanging aluminum coil fin unit of an air conditioning system have a concentration ranging from 1,000 to 10,000 ppm, a particle size generally ranging from 1 to 20 nm, in particular, 1 to 2 nm for exhibiting strong sterilization ability, and a use amount ranging from 100 to 200 ppm.

The above metal nano particles such as Pt, Au, Ag, Cu, TiO₂, etc. are prepared by any one selected from: physical (or mechanical) pulverization; electrical explosion; separation of ions or atoms from target in lump form by plasma processing to obtain metal particles; and a combined process comprising refinement, dissociation and ion reduction of metal salt and compound containing Pt, Au, Ag and Cu or metal salt and compound of TiO₂.

More particularly, Ag nano particles among the metal nano particles are preferably prepared by using metal nano particles from silver nitrate AgNO₃, silver hyperchlorinate AgClO₄, silver chlorinate AgClO₃, silver sulfate Ag₂SO₄ and silver acetate CH₃COOAg as the metal salt and compound thereof.

For the above purpose, Ag nano particles include: Ag nano particles prepared by a process for extracting metallic Ag which uses surfactant receptor and conducts dissociation and ion-reduction of metal salt and compound containing Ag; Ag nano particles prepared by a process for extracting metallic Ag by dissociation and ion-reduction of metal salt and compound containing Ag, and stabilizing the extracted Ag by using silica, zeolite or zirconium phosphate as a carrier; and Ag nano particles prepared by a process for preparing silver nano particles which dissolves polymeric stabilizer of metal salt and compound containing Ag in water or non-aqueous solvent, purges nitrogen to the solution and radiates gamma-rays to the solution.

In case of Ag particles from AgNO₃ raw material, since nitrate groups NO₃— ions as counter ions of silver ions Ag⁺ which are necessarily generated in production of Ag particles from silver compounds such as AgNO₃ cause oxidation and corrosion of a film coated on surface of the aluminum coil fin unit, it is preferable that colloidal Ag particles are produced by removing NO₃— ions using ion-exchange resin or vacuum-distillation method, and admixed with the hydrophilic paint and the rust-resisting paint to form a mixture for coating the aluminum coil fin unit.

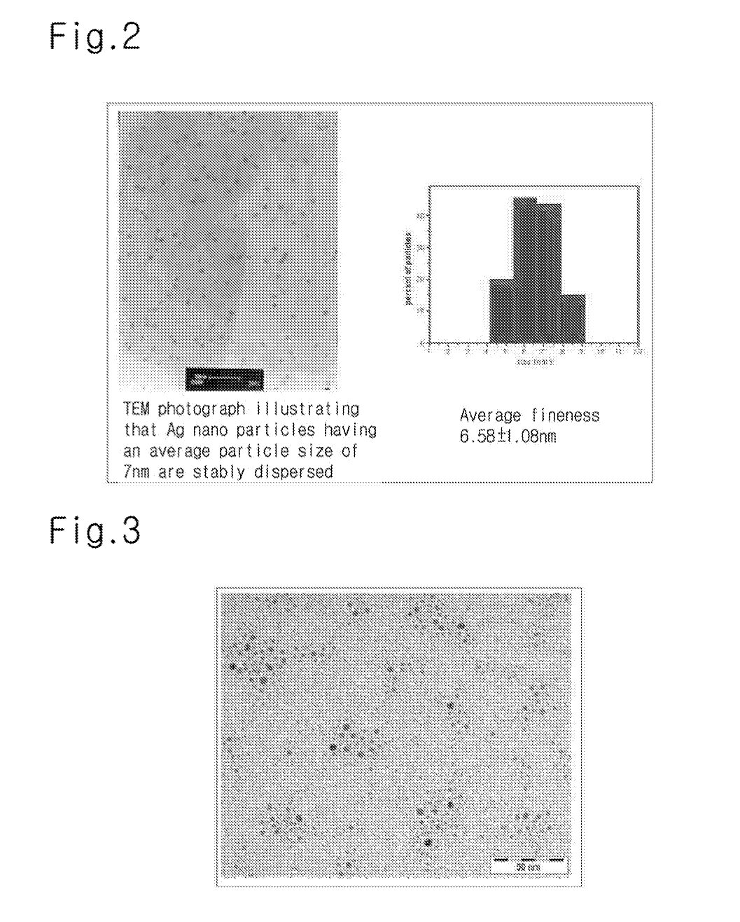

Herein, the metal nano particles are microfine particles having a particle size much smaller than that of conventionally known materials, are sufficiently and homogeneously dispersed in the paint as shown in FIG. 2 and FIG. 3.

The first embodiment of the present invention will be described in detail in reference with accompanying drawings and specific examples. However, it should be understood that the following description and examples are given by way of illustration only and not restricted thereto, and various changes and modifications within the spirit and scope of the invention will become apparent to those skilled in the art from the detailed description.

### EXAMPLE 1

In a process of coating hydrophilic paint on surface of a heat-exchanging aluminum coil fin unit of an air conditioning system, when the hydrophilic paint is added with Ag nano particles with a fineness standard of average 7 mm to dilute the Ag nano particles into a concentration of 200 ppm. A sterilization test was carried out for bacteria such as staphylococcus aureus ATCC 6538P, escherichia coli ATCC 8739 and pseudomonas aeruginosa ATCC 27853 as listed in the following Table 1. The results show that 99% or more of the bacteria is sterilized within 45 minutes (above log 2 in complying with JIS standard).

1. test result;

A sterilization test proposed by a client (in compliance with JIS Z 2801), after lapse of time for 45 minutes, 1 hour, and 3 hours

TABLE

| Section | 45 minutes | 1 hour | 3 hours |
|---|---|---|---|
| | Strain 1 staphylococcus aureus | | |
| Inoculant concentration | 1.3 × 10⁵ | | |
| (CFU/ml) | | | |
| Ma | 1.3 × 10⁵ | | |
| Mb | 1.5 × 10⁵ | 1.8 × 10⁵ | 3.2 × 10⁵ |
| Mc | 4.5 × 10² | <10 | <10 |
| Anti-microbial | 2.5 (99.7%) | 4.3 (99.9%) | 4.5 (99.9%) |
| activity(S)-reduction | | | |
| rate (%) | | | |
| Kind of non-ionic surfactant | TWEEN 80 (0.05%) | | |
| | Strain 2 escherichia coli | | |
| Inoculant concentration | 1.5 × 10⁵ | | |
| (CFU/ml) | | | |
| Ma | 1.5 × 10⁵ | | |
| Mb | 1.9 × 10⁵ | 2.1 × 10⁵ | 4.3 × 10⁵ |
| Mc | 1.5 × 10³ | 6.3 × 10² | <10 |
| Anti-microbial activity(S)- | 2.1 (99.2%) | 2.5 (99.9%) | 4.6 (99.9%) |
| reduction rate (%) | | | |
| Kind of non-ionic surfactant | TWEEN 80 (0.05%) | | |
| | Strain 3 pseudomonas aeruginosa | | |
| Inoculant concentration | 1.4 × 10⁵ | | |
| (CFU/ml) | | | |
| Ma | 1.4 × 10⁵ | | |
| Mb | 1.9 × 10⁵ | 2.0 × 10⁵ | 4.3 × 10⁵ |
| Mc | 3.6 × 10² | <10 | <10 |
| Anti-microbial activity(S)- | 2.7 (99.8%) | 4.3 (99.9%) | 4.7 (99.9%) |
| reduction rate (%) | | | |

| | |
|---|---|
| Kind of non-ionic | TWEEN 80 (0.05%) |
| surfactant | |

Note)
< means “less than”
CFU means Colony Forming Unit

2. test procedure—in compliance with JIS Z 2801

Standard coating film: Stomacher 400 poly-bag

condition: after stationary culture at 35±1° C., RH 90±5% for 45 minutes, 1 hour and 3 hours, respectively, countering number of strains

anti-microbial activity(S): log(Ma/Mb) reduction rate (%): [(Mb−Mc)/Mb]×100

increase ate (%): Mb/Ma (31.6 fold or more)

Ma: average count of viable bacterial cells immediate after inoculation of test strains in a standard sample (3 specimens)

Mb: average count of viable bacterial cells after culturing the standard sample for a constant period such as 45 minutes, 1 hour and 3 hours, respectively (3 specimens)

Mc: average count of viable bacterial cells after culturing a standard processed sample for a constant period such as 45 minutes, 1 hour and 3 hours, respectively (3 specimens)

### EXAMPLE 2

Two samples are prepared, each of which contains diluted colloidal Ag nano particles in a concentration of 1,000 ppm. One of the samples contains NO₃— and the other is free from NO₃—.

Test period and procedure are based on a standard method 1988 of KOTRIC (Korea Testing & Research Institute for Chemical Industry) and the result is shown in the following table.

| | existing silver nano | Silver nano solution |
|---|---|---|
| Section | solution | free from NO₃⁻ |
| Amount NO₃⁻/1,000 ml | 596 ml | 0 |

Next, a method for manufacturing a heat-exchanging coil fin unit according to the second embodiment will be described in detail below.

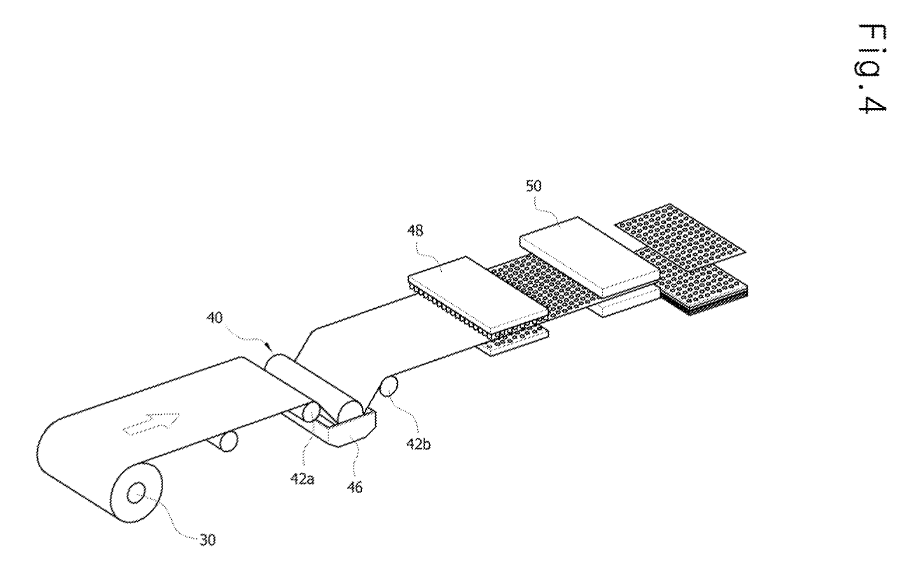

As illustrated in FIG. 4, an assembly is fabricated by: a surface treatment part 40 that comprises an aluminum sheet roll 30 wound by a sheet type of crude panel for fabricating the aluminum coil fin unit and applies lubricant oil or liquid silicone to function as a releasing agent or a mold protective agent to the aluminum sheet in order along a direction of releasing the wound crude panel out of the aluminum sheet roll 30; a punching part 48 that forms a number of punctured holes on the aluminum sheet after surface treating; and a cutting part 50 that cuts the aluminum sheet into pieces meeting standard requirements of finished products.

The surface treatment part 40 has supporting rolls 42a and 42b at both sides and a coating roll 44 between the supporting rolls, of which the coating roll 44 is installed to be partially submerged at lower portion thereof in a coating paint vessel 46 so that a coating film is formed on surface of the crude panel for manufacturing the aluminum coil fin unit when the aluminum crud panel passes through between the coating roll 44 and the coating paint vessel 46.

Metal nano particles used in the second embodiment is Ag nano particles having a concentration of 1,000 to 10,000 ppm, a particle size of 1 to 20 nm and, especially, 1 to 2 nm for keeping a strong sterilization ability, and an amount to be used of 100 to 200 ppm. If it needs anti-microbial ability for only bacteria except fungi, the amount of Ag nano particles to be used is regulated in a range of 10 to 50 ppm and Ag nano particles are used in a mixture form with typical lubricant oil or liquid silicone as the releasing agent or the mold protective agent.

Metal nano particles, in particular, Ag nano particles used in the second embodiment are also prepared by methods similar or substantially same to that used in the first embodiment, more particularly, any one selected from: physical (or mechanical) pulverization; electrical explosion; separation of ions or atoms from target in lump form by plasma processing to obtain metal particles; and a combined process comprising refinement, dissociation and ion reduction of metal salt and compound containing Ag.

More particularly, Ag nano particles are used in the metal salt and compound form prepared by using metal nano particles from AgNO₃, AgClO₄, AgClO₃, Ag₂SO₄ and CH₃COOAg.

For the above purpose, Ag nano particles include: Ag nano particles prepared by a process for extracting metallic Ag which uses surfactant receptor and conducts dissociation and ion-reduction of metal salt and compound containing Ag; Ag nano particles prepared by a process for extracting metallic Ag by dissociation and ion-reduction of metal salt and compound containing Ag, and stabilizing the extracted Ag by using silica, zeolite or zirconium phosphate as a carrier; and Ag nano particles prepared by a process for preparing silver nano particles which dissolves polymeric stabilizer of metal salt and compound containing Ag in water or non-aqueous solvent, purges nitrogen to the solution and radiates gamma-rays to the solution.

In case of Ag particles from AgNO₃ raw material, since nitrate groups NO₃— ions as counter ions of silver ions Ag⁺ which are necessarily generated in production of Ag particles from silver compounds such as AgNO₃ cause oxidation and corrosion of a film coated on surface of the aluminum coil fin unit, it is preferable that colloidal Ag particles are produced by removing NO₃— ions using ion-exchange resin or vacuum-distillation method, and admixed with the hydrophilic paint and the rust-resisting paint to form a mixture for coating the aluminum coil fin unit.

Herein, the metal nano particles are microfine particles having a particle size much smaller than that of conventionally known materials, are sufficiently and homogeneously dispersed in the paint as shown in FIG. 2 and FIG. 3.

The second embodiment of the present invention will be described in detail below in reference with accompanying drawings and specific examples. However, it should be understood that the following description and examples are given by way of illustration only and not restricted thereto.

### EXAMPLE

In a process of coating lubricant oil or liquid silicone as a releasing agent or a mold protective agent on surface of a heat-exchanging aluminum coil fin unit of an air conditioning system, when the releasing agent, lubricant oil or liquid silicone is added with Ag nano particles with a fineness standard of average 7 mm to dilute the Ag nano particles into a concentration of 200 ppm. A sterilization test was carried out for bacteria such as staphylococcus aureus ATCC 6538P, escherichia coli ATCC 8739 and pseudomonas aeruginosa ATCC 27853 as listed in the following Table. The results show that 99% or more of the bacteria is sterilized within 1 hour (above log 2 in complying with JIS standard).

test result; a sterilization test proposed by a client (in compliance with JIS Z 2801), after lapse of time for 45 minutes, 1 hour, and 3 hours

| Section | 45 minutes | 1 hour | 3 hours |
|---|---|---|---|
| | Strain 1 staphylococcus aureus | | |
| Inoculant concentration | 1.3 × 10⁵ | | |
| (CFU/ml) | | | |
| Ma | 1.3 × 10⁵ | | |
| Mb | 1.5 × 10⁵ | 1.8 × 10⁵ | 3.2 × 10⁵ |
| Mc | 4.5 × 10² | <10 | <10 |
| Anti-microbial activity(S)- | 2.7 (99.8%) | 4.3 (99.9%) | 4.5 (99.9%) |
| reduction rate (%) | | | |
| Kind of non-ionic surfactant | TWEEN 80 (0.05%) | | |
| | Strain 2 escherichia coli | | |
| Inoculant concentration | 1.5 × 10⁵ | | |
| (CFU/ml) | | | |
| Ma | 1.5 × 10⁵ | | |
| Mb | 1.9 × 10⁵ | 2.1 × 10⁵ | 4.3 × 10⁵ |
| Mc | 1.5 × 10² | 6.3 × 10² | <10 |
| Anti-microbial activity(S)- | 2.1 (99.2%) | 2.5 (99.7%) | 4.6 (99.9%) |
| reduction rate (%) | | | |
| Kind of non-ionic surfactant | TWEEN 80 (0.05%) | | |
| | Strain 3 pseudomonas aeruginosa | | |
| Inoculant concentration | 1.4 × 10⁵ | | |
| (CFU/ml) | | | |
| Ma | 1.4 × 10⁵ | | |
| Mb | 1.9 × 10⁵ | 2.0 × 10⁵ | 4.3 × 10⁵ |
| Mc | 3.6 × 10² | <10 | <10 |
| Anti-microbial activity(S)- | 2.4 (99.6%) | 2.7 (99.8%) | 4.6 (99.9%) |
| reduction rate (%) | | | |

| | |
|---|---|
| Kind of non-ionic surfactant | TWEEN 80 (0.05%) |

Note)
< means “less than”
CFU means Colony Forming Unit
TWEEN is a tradename of commercially available products

2. test procedure—in compliance with JIS Z 2801

Standard coating film: Stomacher 400 poly-bag

condition: after stationary culture at 35±1° C., RH 90±5% for 45 minutes, 1 hour and 3 hours, respectively, countering number of strains

anti-microbial activity(S): log(Ma/Mb) reduction rate (%): [(Mb−Mc)/Mb]×100

increase ate (%): Mb/Ma (31.6 fold or more)

Ma: average count of viable bacterial cells immediate after inoculation of test strains in a standard sample (3 specimens)

Mb: average count of viable bacterial cells after culturing the standard sample for a constant period such as 45 minutes, 1 hour and 3 hours, respectively (3 specimens)

Mc: average count of viable bacterial cells after culturing a standard processed sample for a constant period such as 45 minutes, 1 hour and 3 hours, respectively (3 specimens)

Next, the third embodiment of the present invention will be described in detail below.

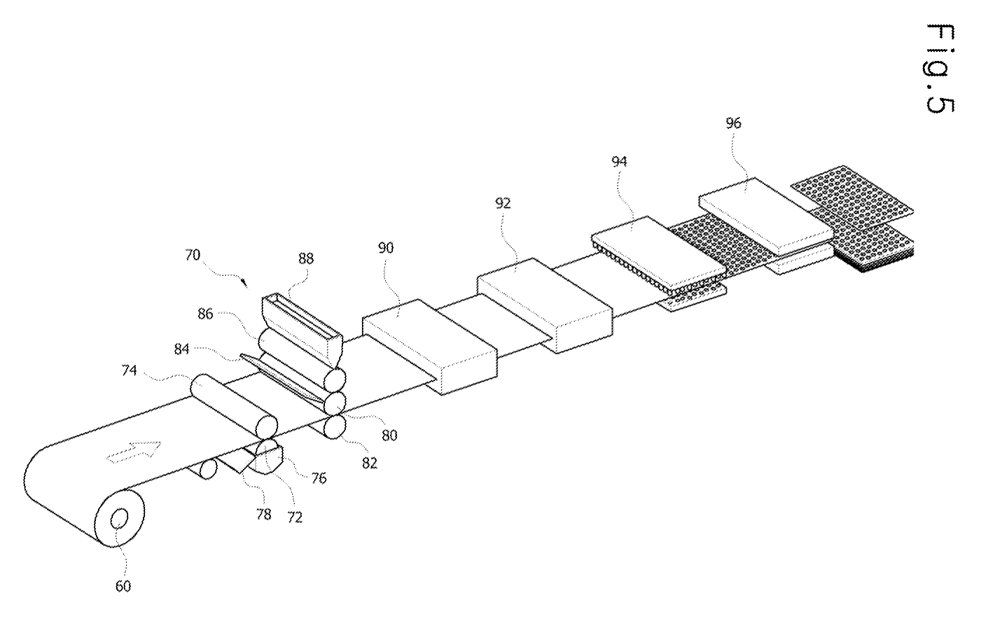

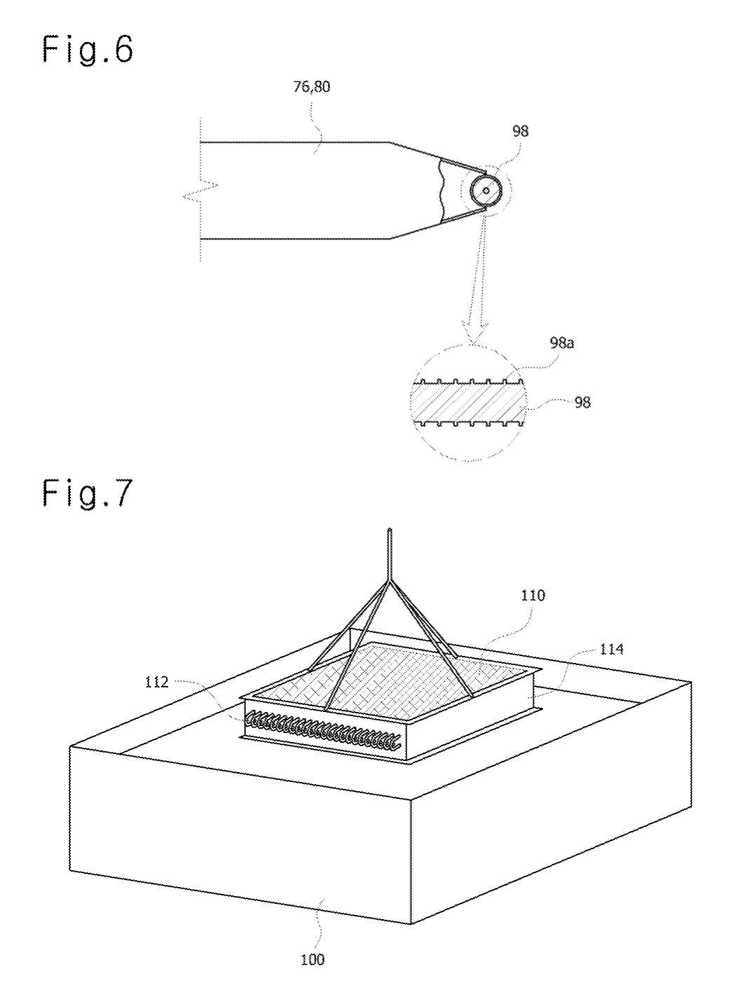

As to the third embodiment, a method for manufacturing a heat-exchanging aluminum coil fin unit by using UV paint coating device 40 to coat surface of aluminum panel for fabricating the aluminum coil fin unit will be described as illustrated in FIG. 5.

First of all, an aluminum sheet roll 60 is provided, around which a sheet type of crude panel for fabricating the aluminum coil fin unit. Along a direction of releasing the crude panel out of the aluminum sheet roll 60, a lower coating roll 72 and a first supporting roll 74 are aligned to face each other, thereby passing the sheet type of crude panel through between the lower coating roll 72 and the supporting roll 74.

A UV paint vessel 76 is placed on bottom of the lower coating roll 72 and enables lower portion of the lower coating roll 72 partially submerged in the vessel 76.

To apply only a constant amount of UV paint to the lower coating roll 72, a first coating thickness control bar 78 is equipped at one side of the lower coating roll 72.

Moreover, an upper coating roll 89 and a second supporting roll 82 are installed at rear of the lower coating roll 72, and a UV paint feeding roll 84 is mounted on the upper coating roll 80 to closely contact with the upper coating roll 80 and pivotally rotate. Alternative UV vessel 88 is placed on the UV paint feeding roll 84 to introduce UV paint to the sheet type of aluminum crude panel which already passed through between the lower coating roll 72 and the first supporting roll 74.

Accordingly, when the UV paint fed from bottom of the UV paint vessel 88 is applied to the UV paint feeding roll 84, the UV paint is applied again to the upper coating roll 80 and form a UV paint film on surface of the sheet type of aluminum crude panel. On the upper coating roll 80, only a constant amount of UV paint is provided by a second coating thickness control bar 84.

Herein, the first and the second coating thickness control bars 78 and 84 apply the paint to the lower coating roll 72 and the upper coating roll 80 in extent of gaps between wires or height of embossing by winding a metal or polymer synthetic wire 98a having diameter of 0.5 to 1.2 μm around cylindrical rollers 98 which are installed at front ends of the control bars, or embossing protrusions with height of 0.5 to 1.2 μm on surface of the cylindrical rollers, and make the sheet type of crude panel for fabricating the aluminum coil fin unit to be coated.

In addition, a ceramic heater drying part 90 using far-infrared ray is fixed on rear of the upper coating roll 80 to remove volatile materials from the UV paint by radiant heat emitted from a ceramic heater.

A UV lamp irradiation part 92 is located at rear of the ceramic heater drying part 90 and completely dries and cures the UV paint.

On rear side of the UV irradiation part 92, a punching part 94 is mounted to form a number of punched holes on the sheet type of crude panel for fabricating the aluminum coil fin unit.

Furthermore, a cutting part 96 is formed at rear of the punching part 94 to cut off the sheet type of crude panel into a desired dimension satisfactory to fabricate the aluminum coil fin unit.

The UV paint includes urethane and acryl based UV paints containing solid content of 5 to 30%, forms the smallest thickness of film with 0.5 to 1.2 μm and reduces the drying time. In order to shorten the drying time, the UV paint has a composition ratio preferably specified by 5 to 10 wt. % of urethane acrylate, 35 to 40 wt. % of ethyl acetate, 5 to 10 wt. % of acryl monomer, 25 to 30 wt. % of toluene, 15 to 20 wt. % of N-butyl acetate and 2 to 5 wt. % of acryl oligomer.

Metal nano particles such as Pt, Au, Ag, Cu, TiO₂, etc. which are added to the UV paint and employed for the coating treatment have a concentration ranging from 1,000 to 10,000 ppm, a particle size of not more than 20 nm and, in particular, 1 to 2 nm for keeping strong sterilization ability, and a use amount ranging from 100 to 200 ppm. However, if it needs anti-microbial ability for only bacteria except fungi, the amount to be is optionally regulated in a range of 10 to 50 ppm and Ag nano particles are used in a mixture form with the UV paint.

The above metal nano particles such as Pt, Au, Ag, Cu, TiO₂, etc. are prepared by any one selected from: physical (or mechanical) pulverization including grinding work; electrical explosion; separation of ions or atoms from target in lump form by plasma processing to obtain metal particles; and a combined process comprising refinement, dissociation and ion reduction of metal salt and compound containing Pt, Au, Ag, Cu, TiO₂, etc.

More particularly, Ag nano particles among the metal nano particles are used in the metal salt and compound form prepared by using AgNO₃, AgClO₄, AgClO₃, Ag₂SO₄ and CH₃COOAg.

For the above purpose, Ag nano particles include: Ag nano particles prepared by a process for extracting metallic Ag which uses surfactant receptor and conducts dissociation and ion-reduction of metal salt and compound containing Ag; Ag nano particles prepared by a process for extracting metallic Ag by dissociation and ion-reduction of metal salt and compound containing Ag, and stabilizing the extracted Ag by using silica, zeolite or zirconium phosphate as a carrier; and Ag nano particles prepared by a process for preparing silver nano particles which dissolves polymeric stabilizer of metal salt and compound containing Ag in water or non-aqueous solvent, purges nitrogen to the solution and radiates gamma-rays to the solution.

In case of Ag particles from AgNO₃ raw material, since nitrate groups NO₃— ions as counter ions of silver ions Ag⁺ which are necessarily generated in production of Ag particles from silver compounds such as AgNO₃ cause oxidation and corrosion of a film coated on surface of the aluminum coil fin unit, it is preferable that colloidal Ag particles are produced by removing NO₃— ions using ion-exchange resin or vacuum-distillation method, and admixed with the UV paint such as urethane based and acryl based VU drying type of paints to form a mixture for coating the aluminum crude panel.

Herein, the metal nano particles are microfine particles having a particle size much smaller than that of conventionally known materials, are sufficiently and homogeneously dispersed in the paint as shown in FIG. 2 and FIG. 3.

The third embodiment of the present invention will be described in detail below in reference with accompanying drawings and specific examples. However, it should be understood that the following description and examples are given by way of illustration only and not restricted thereto.

### EXAMPLE

In a process of coating urethane based and acryl based UV paint on surface of an aluminum crude panel for fabricating a heat-exchanging aluminum coil fin unit of an air conditioning system, when the UV paint is added with Ag nano particles with a fineness standard of average 7 mm to dilute the Ag nano particles into a concentration of 200 ppm. A sterilization test was carried out for bacteria such as staphylococcus aureus ATCC 6538P and pseudomonas aeruginosa ATCC 27853 by using specimens coated with the test mixture as listed in the following Table. The results show that 99% or more of the bacteria is sterilized within 1 hour (above log 4 in complying with JIS standard).

test result; a sterilization test proposed by a client (in compliance with JIS Z 2801), after lapse of time for 1 hour and 3 hours

| Section | 1 hour | 3 hours |
|---|---|---|
| | Strain 1 staphylococcus | |
| | aureus | |
| Inoculant concentration (CFU/ml) | 1.3 × 10⁵ | |
| Ma | 1.3 × 10⁵ | |
| Mb | 1.8 × 10⁵ | 3.2 × 10⁵ |
| Mc | <10 | <10 |
| Anti-microbial activity(S)-reduction rate (%) | 4.3 (99.9%) | 4.5 (99.9%) |
| Kind of non-ionic surfactant | TWEEN 80 (0.05%) | |
| | Strain 2 escherichia coli | |
| Inoculant concentration (CFU/ml) | 1.4 × 10⁵ | |
| Ma | 1.4 × 10⁵ | |
| Mb | 2.0 × 10⁵ | 4.3 × 10⁵ |
| Mc | <10 | <10 |
| Anti-microbial activity(S)-reduction rate (%) | 4.3 (99.9%) | 4.7 (99.9%) |

| | |
|---|---|
| Kind of non-ionic surfactant | TWEEN 80 (0.05%) |

Note)
< means “less than”
CFU means Colony Forming Unit,
TWEEN is a tradename of commercially available products.

2. test procedure—in compliance with JIS Z 2801

Standard coating film: Stomacher 400 poly-bag

condition: after stationary culture at 35±1° C., RH 90±5% for 1 hour and 3 hours, respectively, countering number of strains

anti-microbial activity(S): log(Ma/Mb) reduction rate (%): [(Mb−Mc)/Mb]×100

increase ate (%): Mb/Ma (31.6 fold or more)

Ma: average count of viable bacterial cells immediate after inoculation of test strains in a standard sample (3 specimens)

Mb: average count of viable bacterial cells after culturing the standard sample for a constant period such as 1 hour and 3 hours, respectively (3 specimens)

Mc: average count of viable bacterial cells after culturing a standard processed sample for a constant period such as 1 hour and 3 hours, respectively (3 specimens)

Next, the fourth embodiment of the present invention will be described in detail below.

As to an anti-microbial treatment method of a heat-exchanging aluminum coil fin unit and a housing unit according to the fourth embodiment, metal nano particles selected from a group consisting of microfine Pt, Au, Ag, Cu and TiO₂ alone or in combination with a constant mixing ratio are dipped in an acryl or alkyd based binder containing clay nano particles having a particle size of 10 to 20 nm as shown in FIG. 9.

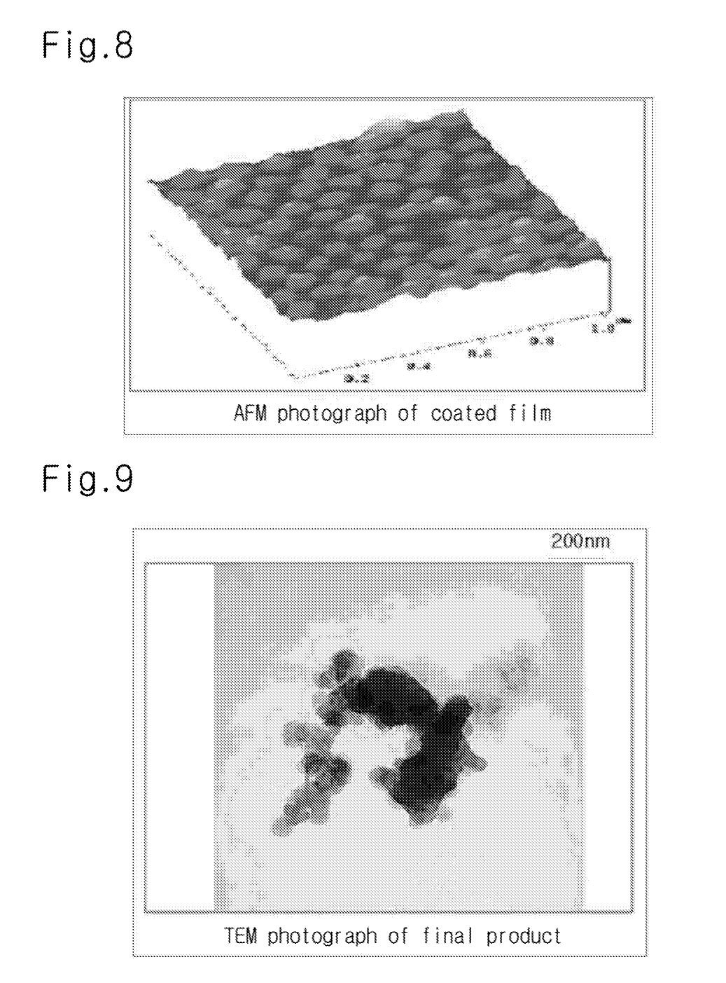

Herein, the binder has preferably a solid content of 5 to 10 wt. % to improve drying velocity. As illustrated in FIG. 7, a process for coating the binder on surfaces of the heat-exchanging coil fin unit and the housing unit comprises dipping the heat-exchanging coil fin unit 100, a copper pipe 112 and the housing unit 114 in a leak removing solution which includes metal nano particles and the acryl based or alkyd based binder in a bath 100 in a leak examination process of finished products by dipping the finished products in the bath 100 containing the leak removing solution, thereby uniformly forming a coating film on surface of the coil fin unit, the copper pipe and the housing unit, as illustrated in FIG. 8.

Metal nano particles in the binder used in the fourth embodiment of the present invention has a concentration of 200 to 300 ppm and a particle size of not more than 20 nm. Especially, in order to continuously maintain the strong sterilization ability, the particle size preferably ranges from 1 to 10 nm and the concentration preferably ranges from 100 to 200 ppm.

If the metal nano particles are microfine particles having the particle size below 20 nm, it can obtain excellent sterilization ability even by adding a smaller amount of the metal nano particles. Furthermore, adhesiveness efficiency of the metal nano particles to the acryl based and alkyd based binder is increased, and the metal nano particles are sufficiently an homogeneously dispersed in the binder as shown in FIG. 2 and FIG. 3.

More particularly, Ag nano particles among the metal nano particles are used in the metal salt and compound form prepared by using AgNO₃, AgClO₄, AgClO₃, Ag₂SO₄ and CH₃COOAg.

Also, in case of Ag particles from AgNO₃ raw material, nitrate groups NO₃— ions must be removed, which are necessarily generated as counter ions of silver ions Ag⁺ in production of Ag particles from silver compounds such as AgNO₃ because nitrate groups NO₃— ions cause oxidation and corrosion of a film coated on surfaces of the aluminum coil fin unit and the housing unit.

Nitrate groups NO₃— ions are removed by conventionally know methods, for example, passing the metal nano particles through an ion-exchange resin or employing vacuum distillation method, so that it is yielded colloidal Ag particles free from the nitrate groups NO₃— ions.

The fourth embodiment of the present invention will be described in detail below in reference with accompanying drawings and specific examples. However, it should be understood that the following description and examples are given by way of illustration only and not restricted thereto.

### EXAMPLE

As to anti-microbial treatment of surfaces of a heat-exchanging aluminum coil fin unit and a housing unit of an air conditioning system, added were 2 wt. % of metal nano particles Ag having a particle size of not more than 7 nm and a concentration of 10,000 ppm, 5 wt. % of clay nano particles having a microfine particle size of 100 nm, and 5 wt. % of an acryl based or alkyd based binder in a bath containing a leak removing solution. A copper pipe as a heat-exchange cooling line was dipped in the bath containing the mixture to examine whether there is leak on surface of the pipe. Also, a finished housing unit was under anti-microbial surface treatment.

After the anti-microbial surface treatment described above, a sterilization test was carried out for bacteria such as staphylococcus aureus ATCC 6538P, escherichia coli ATCC 8739 and pseudomonas aeruginosa ATCC 27853 as listed in the following Tables 1, 2 and 3. The results show that 99% or more of the bacteria is sterilized within 45 minutes.

test result;

A sterilization test proposed by a client (in compliance with JIS Z 2801 and film adhesion procedure 2000), after lapse of time for 45 minutes and 1 hour.

TABLE 1

| | Strain 1 staphylococcus | |
|---|---|---|
| | aureus 6538P | |
| Section | 45 minutes | 1 hour |
| Inoculant concentration (CFU/ml) | 2.5 × 10⁶ | |
| Anti-microbial activity(S)-reduction rate (%) | 99.2% | 99.5% |

| | |
|---|---|
| Kind of non-ionic surfactant | TWEEN 80 (0.05%) |

Note)
< means “less than”
CFU means Colony Forming Unit
TWEEN is a tradename of commercially available products

TABLE 2

| | Strain 2 escherichia | |
|---|---|---|
| | coli ATCC 8739 | |
| Section | 45 minutes | 1 hour |
| Inoculant concentration (CFU/ml) | 3.2 × 10⁶ | |
| Anti-microbial activity(S)-reduction rate (%) | 99.0% | 99.9% |

| | |
|---|---|
| Kind of non-ionic surfactant | TWEEN 80 (0.05%) |

Note)
< means “less than”
CFU means Colony Forming Unit
TWEEN is a tradename of commercially available products

TABLE 3

| | Strain 3 pseudomonas | |
|---|---|---|
| | aeruginosa ATCC 10145 | |
| Section | 1 hour | 1 hour |
| Inoculant concentration (CFU/ml) | 3.9 × 10⁶ | |
| Anti-microbial activity(S)-reduction rate (%) | 99.8% | 99.9% |

| | |
|---|---|
| Kind of non-ionic surfactant | TWEEN 80 (0.05%) |

Note)
< means “less than”
CFU means Colony Forming Unit
TWEEN is a tradename of commercially available products

After sampling specimens from the aluminum coil fin unit of the air conditioning system from the above Example, a fungi resistance test was carried out for the specimens and resulted in that growth of fungi strains is not identified. The result is shown in the following Table 4.

Title of test: identification of fungi resistance

Procedure: in compliance with KS A 0702 (2001)

Condition: 1) species of test strain: aspergillus niger ATCC 6275

2) condition of culturing: temperature of 28-30° C. and relative humidity of 95-99%

TABLE 4

| | Identification of |
|---|---|
| Growth of bacteria in sample | fungi resistance |
| Growth of strains is not identified at inoculation | 3 |
| part of sample or specimen | |
| Area of strain growth identified at inoculation part of | 2 |
| sample or specimen does not exceed ⅓ of total | |
| area | |
| Area of strain growth identified at inoculation part of | 1 |
| sample or specimen exceeds ⅓ of total area | |

### INDUSTRIAL APPLICABILITY

While the present invention has been described with reference to the above detailed description and exemplary embodiments with regard to anti-microbial and/or sterilizing and anti-fungal treatment of a heat-exchanging coil fin unit and a housing unit, it will be understood by those skilled in the art that the present invention is not limited to the above examples and any preparations which are made of light metals and require anti-microbial, anti-fungal and sterilizing effects may be included in the scope of the present invention as defined by the appended claims.

1. A method for manufacturing a heat-exchanging aluminum coil fin unit of an air handling system with anti-microbial function by coating metal nano particles on surface of the aluminum coil fin unit to have anti-microbial ability, which includes steps of: mixing metal nano particles with hydrophilic paint and rust-resisting paint; and applying the paint mixture to surface of the coil fin unit, wherein the metal nano particles are any one selected from a group consisting of platinum Pt, gold Au, silver Ag, copper Cu and titanium dioxide TiO₂ alone or in combination and have a concentration ranging from 1,000 to 10,000 ppm and a particle size of below 20 nm, and the particle size of the metal nano particles preferably ranges from 1 to 2 nm and the concentration of the metal nano particles added to the paint mixture ranges from 100 to 200 ppm.

2. The method according to claim 1, wherein metal nano particles selected from Pt, Au, Ag, Cu and TiO₂ are prepared by any one selected from: physical (or mechanical) pulverization; electrical explosion; separation of ions or atoms from target in lump form by plasma processing to obtain metal particles; and a combined process comprising refinement, dissociation and ion reduction of metal salt and compound containing Pt, Au, Ag and Cu or metal salt and compound of TiO₂.

3. The method according to claim 1, wherein Ag nano particles among the metal nano particles are prepared by the combined process comprising refinement, dissociation and ion reduction of silver nitrate AgNO₃, silver hyperchlorinate AgClO₄, silver chlorinate AgClO₃, silver sulfate Ag₂SO₄ and silver acetate CH₃COOAg as the metal salt and compound.

4. The method according to claim 2, wherein Ag nano particles are prepared by any one selected from: a process for extracting metallic Ag which uses surfactant receptor and conducts dissociation and ion-reduction of metal salt and compound containing Ag; a process for extracting metallic Ag by dissociation and ion-reduction of metal salt and compound containing Ag, and stabilizing the extracted Ag by using silica, zeolite or zirconium phosphate as a carrier; and a process for preparing Ag nano particles which dissolves polymeric stabilizer of metal salt and compound containing Ag in water or non-aqueous solvent, purges nitrogen to the solution and radiates gamma-rays to the solution.

5. The method according to any one of claims 1, wherein the hydrophilic paint and the rust-resisting paint are admixed with colloidal Ag particles which are obtained after removing ions having nitrate groups NO₃— as counter ions of silver ions Ag⁺ generated in production of Ag particles from silver compounds such as AgNO₃ by ion-exchange resin or vacuum-distillation and applied to surface of the heat-exchanging coil fin unit, so that it eliminates cause for oxidation and corrosion of film coated on surface of the coil fin unit.

6. A method for manufacturing a heat-exchanging aluminum coil fin unit of an air handling system with anti-microbial function by punching a sheet type of crude aluminum panel coated with lubricant oil or liquid silicone having function of a releasing agent or a mold protective agent on surface of the panel, which includes steps of adding metal nano particles containing Ag nano particles to the lubricant oil or liquid silicone, applying the coating mixture to surface of the aluminum panel in the sheet form and punching the coated aluminum panel, so that surface of the coil fin unit is coated with the lubricant oil or liquid silicone containing metal nano particles.

7. The method according to claim 6, wherein the coating mixture contains hydro-treated heavy naphtha based lubricant oil or evaporable low viscosity liquid silicone and viscosity of the coating mixture is maintained to a range of 5 to 6 cSt.

8. The method according to claim 6, wherein Ag nano particles among the metal nano particles have a concentration ranging from 1,000 to 10,000 ppm and a particle size of not more than 20 nm, preferably ranging from 1 to 2 nm for improving sterilization ability, and Ag nano particles among the metal nano particles have an amount satisfying that the concentration of Ag nano particles becomes 100 to 200 ppm by comprising 1 to 2 wt. % of a raw material having the concentration of 10,000 ppm and 10 to 20 wt. % of alternative material having the concentration of 1,000 ppm based on total weight of the lubricant oil or liquid silicone for surface treating the coil fin unit.

9. The method according to claim 6, wherein Ag nano particles are prepared by any one selected from: physical (or mechanical) pulverization; electrical explosion; separation of ions or atoms from target in lump form by plasma processing to obtain metal particles; and a combined process comprising refinement, dissociation and ion reduction of metal salt and compound containing Pt, Au, Ag and Cu or metal salt and compound of TiO₂.

10. The method according to claim 6, wherein Ag nano particles are prepared from silver nitrate AgNO₃, silver hyperchlorinate AgClO₄, silver chlorinate AgClO₃, silver sulfate Ag₂SO₄ and silver acetate CH₃COOAg as the metal salt and compound.

11. The method according to claim 6, wherein Ag nano particles are prepared by any one selected from: a process for extracting metallic Ag which uses surfactant receptor and conducts dissociation and ion-reduction of metal salt and compound containing Ag; a process for extracting metallic Ag by dissociation and ion-reduction of metal salt and compound containing Ag, and stabilizing the extracted Ag by using silica, zeolite or zirconium phosphate as a carrier; and a process for preparing silver nano particles which dissolves polymeric stabilizer of metal salt and compound containing Ag in water or non-aqueous solvent, purges nitrogen to the solution and radiates gamma-rays to the solution.

12. The method according to any one of claims 6, wherein the lubricant oil or liquid silicone is admixed with colloidal Ag particles which are obtained after removing ions having nitrate groups NO₃— as counter ions of silver ions Ag⁺ from silver compounds such as AgNO₃ by ion-exchange resin or vacuum-distillation, so that it eliminates oxidation, corrosion and yellowing of film coated on surface of the coil fin unit.

13. A method for manufacturing a heat-exchanging coil fin unit of an air handling system with anti-microbial function by applying UV coating paint to surface of the coil fin unit to have anti-microbial ability, which includes processes of: mixing metal nano particles containing Pt, Au, Ag, Cu and TiO₂ with urethane based and acryl based UV paints; applying the paint mixture to surface of the coil fin unit; and drying/curing, punching and cutting in order the coated coil fin unit.

14. The method according to claim 13, wherein the urethane based and acryl based UV paints have a solid content of 5 to 30 wt. %, a coating film thickness of 0.5 to 1.2 m sufficient for quick drying, and a composition ratio of 5 to 10 wt. % of urethane acrylate, 35 to 40 wt. % of ethyl acetate, 5 to 10 wt. % of acryl monomer, 25 to 30 wt. % o toluene, 15 to 20 wt. % of N-butyl acetate and 2 to 5 wt. % of acryl oligomer.

15. The method according to claim 13, wherein the metal nano particles of Pt, Au, Ag, Cu and TiO₂ have a concentration ranging from 1,000 to 10,000 ppm and a particle size of not more than 20 nm, preferably ranging from 1 to 2 nm for improving sterilization ability, the concentration of the metal nano particles for improving sterilization ability preferably is set up to a range from 100 to 200 ppm, and the concentration of the metal nano particles for simply improving sterilization ability except for anti-fungal function is set up to a range from 10 to 50 ppm.

16. The method according to claim 13, wherein nano particles of Pt, Au, Ag, Cu and TiO₂ are prepared by any one selected from: physical (or mechanical) pulverization; electrical explosion; separation of ions or atoms from target in lump form by plasma processing to obtain metal particles; and a combined process comprising refinement, dissociation and ion reduction of metal salt and compound containing Pt, Au, Ag and Cu or metal salt and compound of TiO₂.

17. The method according to claim 16, wherein Ag nano particles among the metal nano particles are prepared from silver nitrate AgNO₃, silver hyperchlorinate AgClO₄, silver chlorinate AgClO₃, silver sulfate Ag₂SO₄ and silver acetate CH₃COOAg as the metal salt and compound.

18. The method according to claim 16, wherein Ag nano particles are prepared by any one selected from: a process for extracting metallic Ag which uses surfactant receptor and conducts dissociation and ion-reduction of metal salt and compound containing Ag; a process for extracting metallic Ag by dissociation and ion-reduction of metal salt and compound containing Ag, and stabilizing the extracted Ag by using silica, zeolite or zirconium phosphate as a carrier; and a process for preparing silver nano particles which dissolves polymeric stabilizer of metal salt and compound containing Ag in water or non-aqueous solvent, purges nitrogen to the solution and radiates gamma-rays to the solution.

19. The method according to any one of claims 13, wherein the UV paint is admixed with colloidal Ag particles which are obtained after removing ions having nitrate groups NO₃— as counter ions of silver ions Ag⁺ from silver compounds such as AgNO₃ by ion-exchange resin or vacuum-distillation, so that it eliminates oxidation, corrosion and yellowing of film coated on surface of the coil fin unit.

20. An apparatus for manufacturing a heat-exchanging coil fin unit of an air handling system comprising an aluminum sheet roll for winding aluminum sheets, a ceramic heater drying part using far-infrared rays, a UV lamp irradiation part, a punching part and a cutting part,
wherein it further includes: a coating device for applying UV paint containing anti-microbial/hygienic and anti-fungal metal nano particles to surface of the aluminum sheet aligned between the aluminum sheet roll and the ceramic heater drying part; a lower coating roll and a first supporting roll faced each other in the coating device, between which the aluminum sheet passes through; a UV paint chamber located at bottom of the lower coating roll to submerge a part of lower portion of the lower coating roll therein; a first bar for controlling coating thickness which is installed at lateral side of the lower coating roll to smear the lower coating roll with a constant amount of UV paint containing the metal nano particles; an upper coating roll and a second supporting roll positioned at rear of the lower coating roll, between which the aluminum sheet passes through after passing through between the lower coating roll and the first supporting roll; and a second bar for controlling coating thickness which is installed at lateral side of the upper coating roll to feed a constant amount of UV paint containing the metal nano particles from the UV paint chamber that is pivotally adjacent to the upper coating roll, and wherein the first and the second control bars wind a metallic or polymer synthetic wire around a cylindrical roller attached at front end in a constant interval, or give elevation surface of the cylindrical roller to wet the roller with UV paint containing the metal nano particles by a gap of diameter of the roller or height of angle of elevation.

21. A method for manufacturing a heat-exchanging aluminum coil fin unit and a housing unit of an air handling system with anti-microbial function, comprising a leak examination of the heat-exchanging coil fin unit and the housing unit prepared by punching a sheet type of crude aluminum panel and cutting the punched sheet, in which an inorganic anti-microbial agent is admixed with clay and an adhesive binder and the mixture is added to a leak removing solution used in the leak examination process and applied to the coil fin unit and the housing unit, both of which are dipped in the leak removing solution,
wherein the inorganic anti-microbial agent is metal nano particles including Pt, Au, Ag, Cu and TiO₂; the silver Ag is nano particles free from NO₃—; the metal nano particles have a particle size of not more than 20 nm and, preferably 1 to 10 nm; and the metal nano particles have a final concentration ranging from 100 to 200 ppm diluted from a concentration ranging from 1,000 to 50,000 ppm.

22. The method according to claim 21, wherein the adhesive binder comprises acryl copolymer based or alkyd based adhesive binder containing nano clay with a particle size of 10 to 200 ppm and has a low viscosity with a solid content of 5 to 10 wt. %, so that the binder is applied to surface of the coil fin unit and the housing unit by dipping the binder during the leak examination for a copper pipe to fabricate a cooling line of the air conditioning system.
